(19) United States
(12) Patent Application Publication
(10) Pub. No.: US 2010/0316914 A1
(43) Pub. Date: Dec. 16, 2010

(54) Rechargeable battery with aluminium anode containing a non aqueous electrolyte consisting of an ether as solvent and a lithium salt of an imide

(76) Inventor: Pedro Manuel Brito da Silva Correia, (US)

Correspondence Address: Pedro Brito Correia, Rua Prof Egas Moniz 11, Estoril, 2765 218, omitted

(21) Appl. No.: 12/484,214

(22) Filed: Jun. 14, 2009

(51) Int. Cl. H01M 6/22; H01M 6/04

(52) U.S. Cl. 429/306; 429/200

(57) ABSTRACT

A rechargeable battery with aluminium anode containing a non aqueous electrolyte consisting of an ether as solvent and a lithium salt of an imide

It is welt known that the ionisation energy of aluminium to Al³⁺ is about 12 times as big as the ionisation energy of lithium to Li¹⁺. The redox potential however does not reflect this big difference because of the high enthalpy consumed in the formation of aluminium hydroxide when it goes from the anode to the aqueous electrolyte.

Also the use of aqueous electrolyte do not allow the aluminium batteries to be rechargeable, because of the very strong bond between the aluminium and the oxygen atom in the electrolyte.

We propose now a rechargeable battery where the aluminium ion is connected to the nitrogen atom of an imide which improves the redox potential by reducing the enthalpy of formation of the aluminium-nitrogen bond in the salt contained in the electrolyte.

As there are no hydrogen ions in the electrolyte, we found that the addition of a lithium salt of an imide is necessary to improve the characteristics of the battery.

Lithium does not participate in the redox process, it just transports the electric current. The cathode may be carbon or can be made of other metals.

### FIELD OF INVENTION

Rechargeable batteries, batteries for cars, aluminium anode batteries

### BACKGROUND OF THE INVENTION

Environment concerns on fossil fuels which increase the carbon oxide concentration in the atmosphere, economic concerns on the increasing costs of exploring fossil fuels, political concerns on the social stability of the countries where the fossil fuels are located stimulated research on alternative sources of energy.

The most convenient way to transport energy is by converting primary renewable energy sources into electricity, which can be easily transported by metal cables.

The supply of electric energy to transports by car and truck has the difficulty of finding a device which is cheap, and presents a sufficiently large capacity per unit of weight for storage of electricity.

The Argonne laboratories filed several patents on batteries using an aluminium anode and an aqueous electrolyte. They present a big storage capacity per unit weight, they are inexpensive and they are in use for transportations in cars of the US Army.

However, these batteries are not rechargeable.

The difficulty to make aluminium anode batteries rechargeable is the fact that aluminium appears almost exclusively as an ion with 3 positive charges, which correspond to an ionisation energy of about 60 eV. For that reason, the bond Al—O is almost covalent, and needs a lot of energy to be broken. This is the reason why the aluminium production from the ore bauxite (aluminium oxide), is so energy consuming.

### DETAILED DESCRIPTION OF THE INVENTION

We found that using a non aqueous electrolyte has 2 major consequences:
It makes possible to recharge, because the bond Al—N is much weaker than the bond Al—O
The potential redox is increased,
   The redox potential, is the sum of the ionization energy of the single atom, the energy to isolate one atom from the metal structure, and the energy related to the formation of the salt of the anode metal ion with a cation in the electrolyte.

We achieve therefore two important targets. The electrolyte must contain an organic solvent and a salt of lithium, which is the most common salt used in rechargeable batteries.

The lithium salt should not contain an anion of halogens which makes a very stable AlCl⁻⁴ anion. It should also not contain an ion of organic or inorganic acids containing oxygen as the atom with the negative charge to be connected to aluminium.

We found that a convenient anion for the lithium and at the same time for the aluminium salt is Bis(trifluormetlhylsulfono)imide or similar sulfono imide acids.

We found however that phthalimide is sparingly soluble in organic solvents and we dropped it.

We tried of course to find inexpensive and available organic solvents, and we found that 1,2 diethyl ethyleneglycol ether is very suitable.

We made our experiments using a carbon, graphite cathode. The tension which we measured was stable during days.

In this discharge process aluminium ions go into the solution and substitute as cations the lithium ions which are deposited still as ions on the graphite cathode. The carbon atoms of the graphite cathode get a negative electric charge, which they receive from the external cable connecting to the aluminium anode.

After several days of unload, there are aluminium ions in the electrolyte. Then we used a normal device to charge car batteries to make the aluminium ions from the electrolyte to deposit again in the aluminium anode.

However, we found that the weight loss of the aluminium anode by unloading, and the weight increase by loading was under one milligram, very small. This means that the energy produced by unloading is considerable as compared to the weight loss of the anode.

We decided to cross check and to substitute the aluminum anode after unloading by a graphite anode. Then we recharged the battery by making the aluminium ions from the electrolyte to deposit on the graphite electrode substituting the aluminium electrode.

Theoretically the deposit on the graphite electrode could be also made o lithium. By leaving this electrode in water and drying it at the end, we found that the tension between the two graphite electrodes after this recharging was the same as earlier with the aluminium anode and the graphite cathode.

We measured that there was a recharge with a value over 90% as big as the original unlnoad.

### EXAMPLE

We assembled in a 50 ml glass container one aluminium rod with 3 mm diameter and 10 mm length, a graphite cathode with the same dimensions and took as electrolyte 1,2 Diethyl ethyleneglycol ether 20 g Bis(trifluoromethylsulfono)imide lithium salt 2 g We measured a tension of 1,75 Volt which was between 1,60-1,75 during 2 hours. We connected directly the two electrodes in order to reduce the resistance and to increase the electric current during 24 hours.

We took out the aluminium anode and substituted it by a graphite electrode.

We applied a tension of 10 Volt generated by an usual car battery recharger. The negative pole was in the position were earlier the aluminium anode was located.

After 24 hours we stop the recharge operation, took out the graphite electrode which substituted the aluminium anode, merged it in water during 5 minutes to dissolve any lithium metal which could be deposited. The electrode was dried.

After we introduced this electrode in the electrolyte, we measured the same tension as initially we found for the aluminum anode.

### BIBLIOGRAPHY

1. U.S. Pat. No. 4,146,679

2. U.S. Pat. No. 4,942,100

3. U.S. Pat. No. 5,032,474

4. U.S. Pat. No. 5,549,991

5. U.S. Pat. No. 5,910,382

6. U.S. Pat. No. 7,314,682

7. J-P 6079673

We propose a rechargeable battery with aluminium anode, where the aluminium ion going to the non aqueous electrolyte is connected to the nitrogen atom of an imide.

This improves the redox potential as compared to earlier batteries with aqueous electrolytes, and makes the battery rechargeable, by reducing the enthalpy of formation of the aluminium ion bond to the oxygen of the anion contained in the aqueous electrolyte.

As there are no hydrogen ions in our electrolyte, we found that the addition of a lithium salt of the imide is necessary to improve the conductivity of the electrolyte.

Lithium does not participate in the redox process, it just transports the electric current. The cathode may be carbon or can be made of other metals.

1. A rechargeable battery consisting of an aluminium anode, a graphite cathode or a Zinc, Cadmium or Nickel cathode, a non aqueous electrolyte containing a lithium salt of Bis(trifluoromethylsulfono)imide or another similar fluoroalkylsulfono imide

2. In the product of claim 1 where the purity of the aluminium anode may be 99,5 to 99,9999

3. In the product of claim 1 where the aluminium anode can be doped with small quantities of metals or metalloids to improve its properties, which may be but are not limited to selen, zinc, beryllium.

4. In the product of claim 1 where the form of the electrodes and the geometry of the electrolyte space can be adapted to the needs of the application and may therefore contain electrodes as rods, sheets plane or cylindrical and the distances between electrodes may vary from 0,1 to 10 mm.

5. In the product of claim 1 where the electrolyte is impregnated in a porous polymer
